(19) United States
(12) Patent Application Publication
(10) Pub. No.: US 2008/0251743 A1
(43) Pub. Date: Oct. 16, 2008

(54) Valve for a Container, Preferably a Cylinder Containing High Pressure Gas

(75) Inventors: Giacomo Giovangrossi, Aprilia (IT); Daniele Andreozzi, Aprilia (IT)

Correspondence Address: YOUNG & THOMPSON, 209 Madison Street, Suite 500, ALEXANDRIA, VA, 22314, US

(73) Assignee: AERO SEKUR S.P.A., Aprilia (IT)

(21) Appl. No.: 12/066,495

(22) PCT Filed: Sep. 7, 2006
(86) PCT No.: PCT/IT06/00649

§ 371 Date: Apr. 3, 2008

(30) Foreign Application Priority Data
Sep. 12, 2005 (IT) RM2005A000465

(51) Int. Cl. F16K 31/66; F16K 31/02

(52) U.S. Cl. 251/11; 251/318; 251/368

(57) ABSTRACT

The present invention relates to an improved valve (1) for a container (2), preferably a cylinder containing high pressure gas, comprising a body (3, 4), provided on a orifice of said container (2), said body (3, 4) providing a cavity wherein means (12, 14) are provided for actuating a shutter (11) suitable to close said container (2) orifice, said valve (1) being characterised in that said activation means (12, 14) comprise means (16) made up of shape memory alloy; and in that it comprises means for modifying temperature of said activation means (16), so as to permit change of state of said alloy from martensitic state into austenitic state and vice versa, said activation means (16) thus varying their shape causing translation of said shutter (11) and thus opening of said valve by said activation means (12, 14).

The present invention relates to an improved valve for a container, preferably a cylinder containing high pressure gas.

More specifically, the invention concerns a valve that can be used for inflation systems, particularly studied and realised for obtaining a high speed operation, thus permitting a fast inflation of pneumatic structures.

As it is well known, various devices or systems exist to guarantee quick opening of pneumatic structures, using high pressure cylinders.

Devices are required in the earth, aeronautic and aerospace fields able ensuring very short times for opening cylinders containing high pressure gas such as nitrogen (N), helium (He), carbon dioxide (CO₂), ecc.

A typical example of use of the above inflation systems is the emergency apparatuses for helicopters.

It is known that helicopters are provided with emergency floatings. In case a helicopter is obliged to an emergency alighting on the water, it is necessary provided valves permitting a quick inflation of said floatings.

Said inflation systems are often used in the aerospace field, particularly for pneumatic structures, e.g. when returning in the atmosphere, for support structures, airbags, ecc.

Among the various kinds of said valves, it is possible mentioning those providing electromechanical actuators. They are usually comprised of a solenoid on which current is made passing for activation of the device. Current passing through said solenoid permits displacement by Lorenz force of a mechanical element opening the high pressure cylinder valve.

Systems using said kind of valves has the drawback that they do not reach high application speed. Further, said devices require high currents for their activation, this implying a high power absorption. Therefore, said devices require power accumulators, thus raising costs of the final system and weight to be installed on the helicopter.

Finally, solenoid devices are not too much reliable.

Another kind of valves provides the use of pyrotechnic devices. They are comprised of a detonation device, ensuring noticeable reaction times.

However, notwithstanding their efficiency, said systems has the following drawbacks:
they are not much reliable, and also in view of this reason, they are presently not used in the aerospace field, requiring valves ensuring a 100% activation probability;
they have a short life;
once used said valves must be replaced, this not being required by the other valves, e.g. those with electromechanical activation. This implies a cumbersome maintenance of the inflation system.

Thus, it is well evident that these last systems are very expensive.

Object of the present invention is therefore that of suggesting a valve permitting a high reliability.

Another object of the present invention is that said valve can be rechargeable, thus permitting its multiple use.

It is therefore specific object of the present invention an improved valve for a container, preferably a cylinder containing high pressure gas, comprising a body, provided on a orifice of said container, said body providing a cavity wherein means are provided for actuating a shutter suitable to close said container orifice, said valve being characterised in that said activation means comprise means made up of shape memory alloy; and in that it comprises means for modifying temperature of said activation means, so as to permit change of state of said alloy from martensitic state into austenitic state and vice versa, said activation means thus varying their shape causing translation of said shutter and thus opening of said valve by said activation means.

Always according to the invention, said shape memory alloy can be a Ni—Ti alloy.

Still according to the invention, said activation means can comprise a spring, said spring being:
compressed when the valve is closed and the shape memory alloy is in the martensitic state;
extended when the valve is opened and the shape memory alloy is in the austenitic state.

Furthermore, according to the invention, said shutter can comprise a stem and sealing gaskets.

Advantageously, according to the invention, said activation means can comprise a lock bolt and one or more spheres placed in one or more cavities of said lock bolt to keep the same constrained when said activation means do not open said valve.

Always according to the invention, said activation means can comprise preloaded retaining means, such as a spring, permitting, when said lock bolt is free, causing its movement.

Preferably, according to the invention, said valve can comprise retaining means, such as a spring, between said lock bolt and said body suitable to permit restoring closure position of said valve.

Always according to the invention, said body can be comprised of a head, placed on the orifice of said container and comprising a substantially horizontal channel communicating with said orifice of said cylinder, and of an activation device, fixed to said head by interposition of spacers, said activation device comprising said shutter in a substantially horizontal position in correspondence of said head channel, so that, when said valve is closed, said shutter being inserted in said channel.

Still according to the invention, said body can comprise one or more threaded holes for connection of auxiliary devices, such as a manometer and/or a safety valve.

Furthermore, according to the invention, said means for varying the temperature, can comprise an electric resistance and means for supplying said electric resistance.

The present invention will be now described, for illustrative but not limitative purposes, according to its preferred embodiments, with particular reference to the figures of the enclosed drawings, wherein:

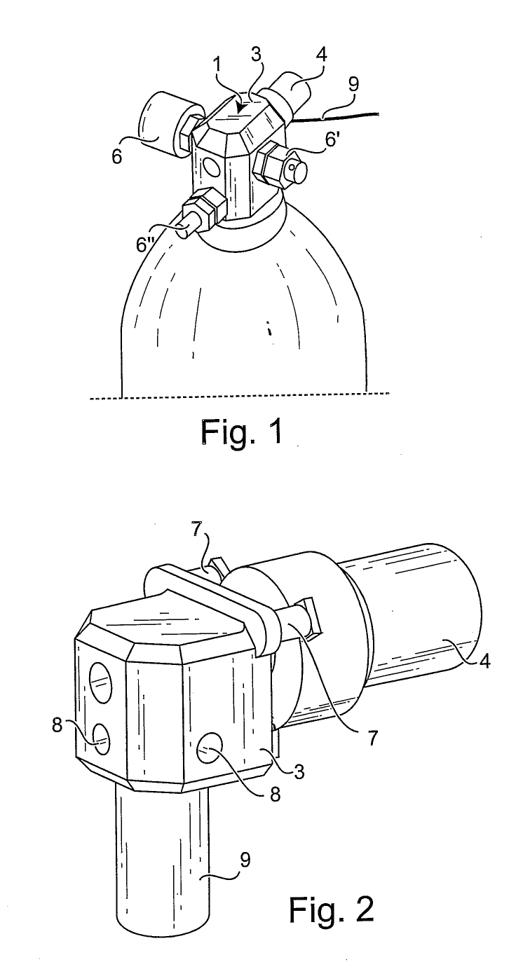

FIG. 1 shows a perspective view of the improved valve according to the present invention, installed on a high pressure cylinder;

FIG. 2 shows a perspective of the improved valve according to the present invention;

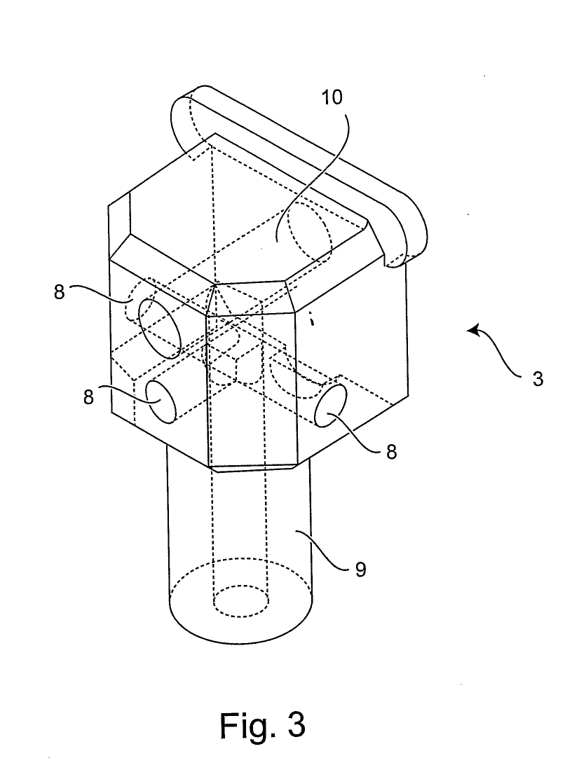

FIG. 3 shows a perspective view of the head of the valve according to the present invention;

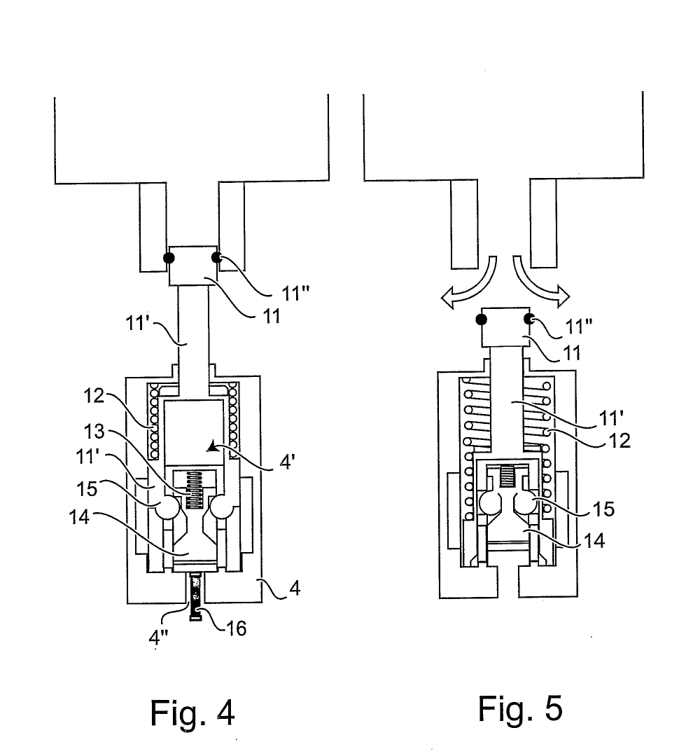

FIG. 4 shows a section scheme of an activation device of valve according to the present invention in a closure position; and

FIG. 5 shows a section scheme of the activation device of FIG. 4 in an open position.

Making reference to FIG. 1, it is possible observing application a valve 1 on a high pressure cylinder 2.

Said valve 1 mainly comprises a head 3, and a shape memory activation device 4. Control of said valve 1 occurs electrically. Particularly, making current passing along activation wires 5. activation device is activated, opening valve 1. in this way, high pressure gas contained within the cylinder 2 can freely exit, inflating connected pneumatic structures.

From FIG. 1 it is noted that standard auxiliary devices can be connected with head 3. Particularly, in the present case, a manometer 6 and overpressure safety valve 6′ and a service valve 6″ are connected.

FIGS. 2 and 3 show more specifically connection between head 3 and activation device 4.

Three spacers 7 are provided between said head 3 and said activation device 4. said head 3 also comprises threaded holes 8, suitable for fixing said auxiliary devices 6, 6′, 6″.

Base 9 of head 3 is fixed on cylinder 2 and provides inside a vertical channel 9′ for passage of gas, communicating with a further substantially horizontal through channel, always in the head 3, in correspondence of the activation device 4 application.

Said channel 10 is suitable to permit passage of shutter (see the following figures) opening valve 1.

Making now reference to FIGS. 4 and 5, it is possible examining how valve 1 according to the invention opens.

A cavity 4′ inside the activation device 4 is shown in FIG. 4, wherein a plurality of components is inserted, said components comprising:
a shutter 11, with a stem 11′, within said channel 10. Said shutter 11 is connected with the stem and is provided of sealing gaskets 11″ permitting maintaining closed orifice communicating with cylinder 2;
a first activation spring 12, placed between said cavity 4′ and convex surface of a “U” inverted structure fixed at the rear end of said pin 11′;
a second restore spring, connected with a lock bolt 14, said lock bolt 14 providing spheres 15. Said lock bolt 14 and said restore spring 13 are placed within said cavity 4′;
a third activation spring 16, housed within channel 4″, connected with said lock bolt 14.

Spring 16 is comprised of a shape memory alloy, that, when at a transition temperature, is able passing from a martensitic state to an austenitic state. Particularly, in the present embodiment, said spring 16 is comprised of Ni—Ti alloy and transition temperature is of about 100° C.

A heating resistance (not shown in the figures) is provided close to said activation spring 16, supplied by said wires 5. Said resistance heats activation spring 16. When activation spring 16 reaches transition temperature by said resistance, it passes from martensitic state to austenitic state, lengthening within a very reduced time, thus generating a very intense pulse. Activation spring 16 moves spheres 15, leaving lock bolt 14 free. Now, preloaded spring 12, lengthening, displaces shutter 11 releasing gas contained within cylinder 2, thus opening valve 1.

Said valve 1 can be reloaded for a new activation, by the following steps:
lowering activation spring 16 temperature, thus permitting transition of shape memory alloy from austenitic state to martensitic state;
pushing lock bolt 14 backward;
loading activation springs 12 thanks to the restore spring 13;
permitting spheres 15 positioning again for blocking lock bolt 14.

Valve 1 can operate between −60° C. and +70° C. Furthermore, as already said, said valve 1 can be reloaded and reused. Present embodiment ensures at least 100 restoring of the system.

Activation absorption is between 0.75 and 2.5 Ampere, permitting activating shutter 11 within few milliseconds.

On the basis of the previous specification, it can be observed that basic feature of the present invention is that valve according to the invention permits very quick opening times, permitting designing high speed inflations systems and, at the same time, maintaining a high reliability.

An advantage of the present invention is that of permitting the plural use of the device, thus allowing an economic saving.

The present invention has been described for illustrative but not limitative purposes, according to its preferred embodiments, but it is to be understood that modifications and/or changes can be introduced by those skilled in the art without departing from the relevant scope as defined in the enclosed claims.

1-15. (canceled)

16. Improved valve (1) attachable to a container (2), preferably a cylinder containing high pressure gas, comprising
a body, provided on a orifice of said container (2), said body (3, 4) providing a cavity wherein activation means (12, 14) are provided for driving a shutter (11) suitable to close said container orifice, said valve (1) being characterised in that it comprises
actuating means (16) made up of shape memory alloy; and
means for modifying temperature of said actuating means (16) made up of shape memory alloy, so as to change state of said alloy from martensitic state into austenitic state, said actuating means (16) made up of shape memory alloy thus varying their shape causing translation of said shutter (11) and thus opening of said valve by said activation means (12, 14), and vice versa, to restore after the operation said valve (1);
and in that said activation means comprise a lock bolt (14), which has one or more cavities, one or more spheres (15), placed in said one or more cavities of said lock bolt (14) to keep the same constrained when said activation means do not open said valve (1), and a preloaded retaining means (12), suitable to cause the movement of said lock bolt (14) when said lock bolt (14) is free.

17. Valve (1) according to claim 16, characterised in that said shape memory alloy is a Ni—Ti alloy.

18. Valve (1) according to claim 16, characterised in that said activation means comprise a spring (12), said spring being:
compressed when the valve (1) is closed and the shape (16) memory alloy is in the martensitic state;
extended when the valve (1) is opened and the shape (16) memory alloy is in the austenitic state.

19. Valve (1) according to claim 16, characterised in that said shutter (11) comprises a stem (11′).

20. Valve (1) according to claim 16, characterised in that said shutter (11) comprises sealing gaskets (11″).

21. Valve (1) according to claim 16, characterised in that said preloaded retaining means comprises a spring.

22. Valve according to claim 16, characterised in that comprises retaining means, such as a spring (13), between said lock bolt and said body (4) suitable to permit restoring closure position of said valve (1).

23. Valve (1) according to claim 16, characterised in that said body is comprised of a head, placed on the orifice of said container and comprising a substantially horizontal channel communicating with said orifice of said cylinder, and of an activation device, fixed to said head by interposition of spacers, said activation device comprising said shutter (11) in a substantially horizontal position in correspondence of said head channel, so that, when said valve is closed, said shutter being inserted in said channel.

24. Valve (1) according to claim 16, characterised in that said body comprises one or more threaded holes (8) for connection of auxiliary devices (6, 6′, 6″).

25. Valve according to claim 24, characterised in that said auxiliary devices comprise a manometer (6) and/or a safety valve (6′).

26. Valve (1) according to claim 16, characterised in that said means for varying the temperature comprise an electric resistance.

27. Valve (1) according to claim 26, characterised in that said means for varying the temperature comprise means for supplying said electric resistance.

28. Valve (1) according to claim 17, characterised in that said activation means comprise a spring (12), said spring being:
compressed when the valve (1) is closed and the shape (16) memory alloy is in the martensitic state;
extended when the valve (1) is opened and the shape (16) memory alloy is in the austenitic state.

29. Valve (1) according to claim 17, characterised in that said shutter (11) comprises a stem (11′).

30. Valve (1) according to claim 17, characterised in that said shutter (11) comprises sealing gaskets (11″).

31. Valve (1) according to claim 17, characterised in that said preloaded retaining means comprises a spring.

32. Valve according to claim 17, characterised in that comprises retaining means, such as a spring (13), between said lock bolt and said body (4) suitable to permit restoring closure position of said valve (1).

33. Valve (1) according to claim 17, characterised in that said body is comprised of a head, placed on the orifice of said container and comprising a substantially horizontal channel communicating with said orifice of said cylinder, and of an activation device, fixed to said head by interposition of spacers, said activation device comprising said shutter (11) in a substantially horizontal position in correspondence of said head channel, so that, when said valve is closed, said shutter being inserted in said channel.

34. Valve (1) according to claim 17, characterised in that said body comprises one or more threaded holes (8) for connection of auxiliary devices (6, 6′, 6″).

35. Valve (1) according to claim 17, characterised in that said means for varying the temperature comprise an electric resistance.
